(19) United States
(12) Patent Application Publication
(10) Pub. No.: US 2009/0167702 A1
(43) Pub. Date: Jul. 2, 2009

(54) Pointing device detection

(75) Inventor: Mikko Nurmi, Tampere (FI)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 12/006,478

(22) Filed: Jan. 2, 2008

(51) Int. Cl. G06F 3/041

(52) U.S. Cl. 345/173

(57) ABSTRACT

A method of controlling a user interface of an apparatus including sensing a first angular position of a pointing device relative to the user interface of the apparatus; and performing an operation based, at least partially, upon the sensed first angular position of the pointing device. An apparatus including a first section including a user interface comprising a touch sensor; and a sensor system for determining an angular position of a pointing device relative to a portion of the first section.

### BACKGROUND OF THE INVENTION

1. Field of the Invention

The invention relates to a user input and, more particularly, to a user input comprising a pointing device.

2. Brief Description of Prior Developments

Electronic devices are known which use a touch screen and perhaps a stylus or finger for inputting information or making selections, such as depressing icons on the touch screen. Such devices include, for example, a laptop computers, a PDA, a mobile telephone, a gaming device, a music player, a digital camera or video camera, and combinations of these types of devices or other devices.

In current solutions, possibilities of touch screen interaction methods are not fully utilized. There is a desire to provide a stylus and/or finger based interaction which can be further developed. By using a pointing device in different ways, a user should be able to change the way information is shown on the screen. In current solutions, a user is not able to make different selections by pressing a same area on the screen. There is a desire to allow a user to press a same area on the screen to make different selections.

In current solutions of capacitive touch screen devices, the device can detect the place or direction where the stylus comes over the screen, but does not act based upon this information. There is a desire to provide a device which can act based upon detection of the place or direction where a pointing device comes over the screen.

In current solutions there has not been an implementation that would detect the direction of a pointing device when the pointing device is moved outside the screen area over a capacitive touch screen area. Detection of this information would enable implementation of different functionalities that can be affected by the direction of pointing device.

### SUMMARY OF THE INVENTION

In accordance with one aspect of the invention, a method of controlling a user interface of an apparatus is provided comprising sensing a first angular position of a pointing device relative to the user interface of the apparatus; and performing an operation based, at least partially, upon the sensed first angular position of the pointing device.

In accordance with another aspect of the invention, a method of controlling a user interface of an apparatus is provided comprising sensing a first angular position of a pointing device relative to the user interface of the apparatus; sensing a second different angular position of the pointing device relative to the user interface; and performing a first operation based, at least partially, upon change of the pointing device between the first angular position and the second angular position.

In accordance with another aspect of the invention, a method of controlling a user interface of an apparatus is provided comprising sensing a direction of movement of a pointing device relative to the user interface of the apparatus while the pointing device is spaced from the apparatus, and/or determining a location of the pointing device based upon movement of the pointing device at the location relative to the user interface of the apparatus while the pointing device is spaced from the apparatus; and performing a first operation based, at least partially, upon the sensed direction of movement and/or the determined location of the pointing device.

In accordance with another aspect of the invention, a program storage device is provided which readable by an apparatus, tangibly embodying a program of instructions executable by the apparatus for performing operations to enter a selection into the apparatus, the operations comprising sensing a direction of movement of a pointing device relative to the apparatus while the pointing device is spaced from the apparatus and/or determining a location of the pointing device based upon movement of the pointing device at the location relative to the user interface of the apparatus while the pointing device is spaced from the apparatus; and performing an operation based, at least partially, upon the sensed direction of movement and/or the determined location of the pointing device relative to the apparatus for at least partially entering the selection into the apparatus.

In accordance with another aspect of the invention, a program storage device is provided which is readable by an apparatus, tangibly embodying a program of instructions executable by the apparatus for performing operations to enter a selection into the apparatus, the operations comprising sensing an angle of a pointing device relative to the apparatus while the pointing device is on the apparatus; and performing an operation based, at least partially, upon the sensed angle of the pointing device relative to the apparatus for at least partially entering the selection into the apparatus.

In accordance with another aspect of the invention, an apparatus is provided comprising a first section including a user interface comprising a touch sensor; and a sensor system for determining an angular position of a pointing device relative to a portion of the first section.

In accordance with another aspect of the invention, an apparatus is provided comprising a first section comprising electronic circuitry including a touch sensor; a pointing device adapted to be moved relative to the first section; and a sensor system on the first section and/or the pointing device for sensing the pointing device relative to the first section while the pointing device is spaced from the first section. The electronic circuitry is adapted to perform an operation based, at least partially, upon the sensing by the sensor system of the pointing device relative to the first section while the pointing device is spaced from the first section.

### BRIEF DESCRIPTION OF THE DRAWINGS

The foregoing aspects and other features of the invention are explained in the following description, taken in connection with the accompanying drawings, wherein:

FIG. 1 is a perspective view of an apparatus comprising features of the invention;

FIG. 2 is a diagram illustrating some of the components of the apparatus shown in FIG. 1;

FIG. 3 is perspective view of the apparatus as in FIG. 1 with the stylus moved to another location and angle;

FIG. 4 is a front plan view of the touch screen shown in FIG. 1 with a first display screen shown, and showing two angles of contact with the stylus at a same location;

FIG. 5 is an alternate version of the messaging icon shown in FIG. 4;

FIG. 6A is a perspective view of a device with a touch screen along substantially an entire face of the device;

FIG. 6B is a perspective view of the device shown in FIG. 6A with a different display screen shown;

FIG. 7A is a front plan view of a display image on the device shown in FIG. 1 showing a 2D map image and the stylus contacting the map image at a specific angle;

FIG. 7B is a front plan view of a display image on the device shown in FIG. 1 showing a 3D map image resulting from the stylus contacting the map image shown in FIG. 7A;

FIG. 8 is a front plan view of a device showing different directions of entry of the stylus into an area over the touch screen;

FIG. 9 is a front plan view of the device shown in FIG. 8 showing different directions of exit of the stylus from the area over the touch screen;

FIG. 10 is a front plan view of the device shown in FIG. 8 showing different angled directions of entry of the stylus into an area over the touch screen;

FIG. 11 is a front plan view showing directions of exit and entry of the stylus from the area over the keypad which can be sensed and used by the electronics of the device;

FIG. 12 is a perspective view of an alternate embodiment of the invention;

FIG. 13 is a front view of another alternate embodiment of the invention;

FIG. 14 is a perspective view of another alternate embodiment of the invention;

FIG. 15 is a block diagram illustrating step for one method of the invention;

FIG. 16 is a block diagram illustrating step for one method of the invention; and

FIG. 17 is a block diagram illustrating step for one method of the invention.

### DETAILED DESCRIPTION OF THE PREFERRED EMBODIMENTS

One of the features of the invention is related to touch screens and to the way how information is shown on the screen. One of the features of the invention is also related to usability and information readability as it improves both of these. A main feature of the invention is related to a stylus and its use with a touch screen. According to this feature, a touch screen device and/or a stylus is able to detect an angle between the touch screen area and the stylus. This information can then be used to control the device, such as change the appearance of information on the screen, etc.

The invention can be implemented on devices with different kind of touch functionality. Touch functionality can mean a touch screen, such as a capacitive touch screen or any other type of touch screen. The invention is also applicable for other devices using technologies that enable detecting stylus or finger movement spaced above a screen, such as based upon camera image, sensor information or something else for example. Touch functionality can also mean touch areas outside an actual device touch screen, or it can mean a touch sensitive keypad such as in some conventional devices already in the marketplace.

In conventional solutions, possibilities of touch screen interaction methods are not fully utilized. Stylus based interaction can be further developed as this invention shows. By using a stylus in different ways, a user should be able to change the way information is shown on the screen. In conventional solutions, a user is not able to make different selections by pressing a same area on a display screen with different angles of stylus. With the invention, an angle of the stylus can be used to change the appearance of the screen or operations of the device.

In conventional solutions of capacitive touch screen devices the device does detect the place or direction where the stylus comes over the screen. However, this detected information has not been used in the past to affect an operation of the device based on this information. In addition, in conventional solutions there has not been an implementation that would detect the direction of a stylus when the stylus is moved outside the screen area; spaced over the capacitive touch screen area. Detection and use of this information can enable implementation of different functionalities that could be affected by the direction of stylus (when moved over the top of the touch screen area, but spaced from the touch screen).

The invention can be related to touch screens and a way to affect the touch screen appearance with a touch sensor actuator or pointing device, such as a stylus or a finger of a user for example. The “stylus” can be a dedicated device (with an optional ability to detect its angle by itself) or any other suitable pointing device. The invention may be mainly software related, such as if it uses a conventional capacitive touch screen. A capacitive touch screen is able to detect the stylus near and above the screen area even if the screen is not touched by the stylus. This makes it possible for the touch screen software to detect when the stylus is moved above the screen area. In an alternate embodiment as an alternative to a capacitive touch screen, any suitable technology for sensing the pointing device while the pointing device is spaced above the touch screen, and/or while the pointing device is on the touch screen, could be used. With this feature, when the user moves the stylus from outside the screen area to the screen area, the device software can detect the place on the edge of the screen where stylus came to the screen area. Depending on the place on the screen edge where the stylus was moved in, the device software can act differently. By moving the stylus to the screen area from different directions, a user can make different kinds of selections. The invention can be used both in stylus and finger touch solutions.

In the following examples, a capacitive touch screen can detect the place where the stylus moves to the screen area, or a device body part can be capacitive, and sense the place of the stylus before the stylus moves directly into contact on the touch screen.

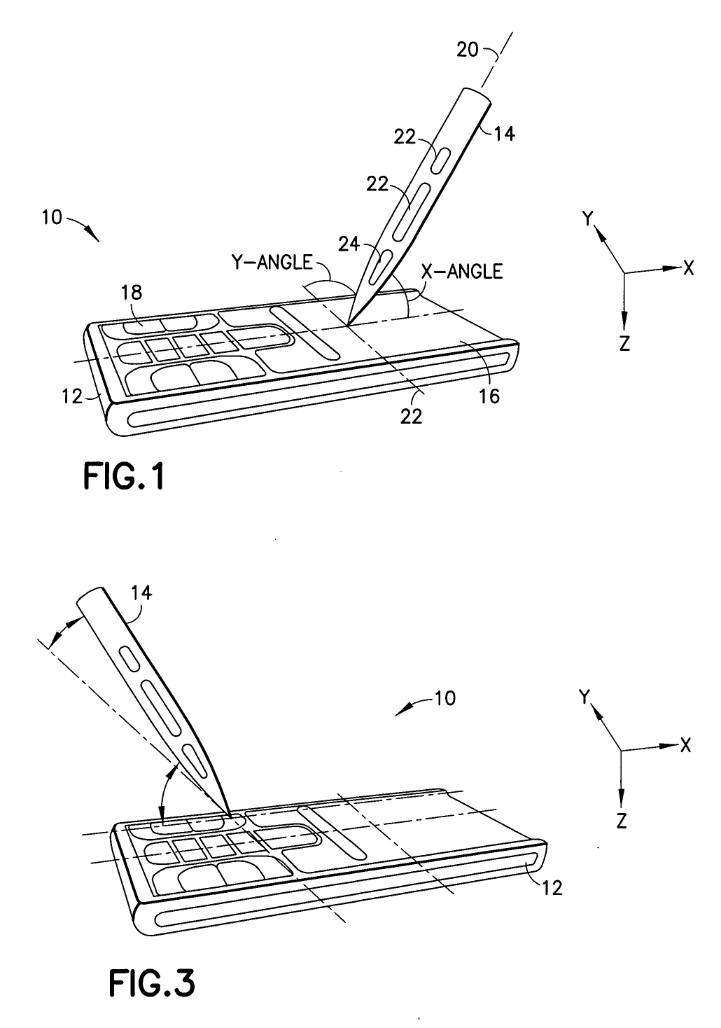

Referring to FIG. 1, there is shown a perspective view of an apparatus 10 incorporating features of the invention. Although the invention will be described with reference to the exemplary embodiments shown in the drawings, it should be understood that the invention can be embodied in many alternate forms of embodiments. U.S. patent application Ser. No. 11/473,836 filed on Jun. 23, 2006, which is hereby incorporated by reference in its entirety, discloses a concept regarding direction of stylus input.

The apparatus, in this embodiment, generally comprises a device 12 and a stylus 14. The device 12 is a hand-held portable electronic device, such as a mobile telephone for example. As is known in the art, a mobile telephone can comprise multiple different types of functionalities or applications, such as a music player, a digital camera and/or digital video camera, a web browser, a gaming device, etc. In alternate embodiments, features of the invention could be used in other types of electronic devices, such as a laptop computer, a PDA, a music player, a video camera, a gaming handset, etc. Features of the invention could be used in a non-hand-held device, such as a machine or other device having a touch screen.

A feature of this invention is to detect different ways of a user's interaction with a device having a touch screen using the combination of the device and a stylus. One feature of the invention is to detect or sense an angle of the stylus while the user is using the stylus on the touch screen. It is not possible to demonstrate all the possible use cases when using a determination of the angle of stylus to use a device. Instead, some examples describing the idea are described below. The invention could also be used with a touch sensitive area which is not a touch screen. The touch sensitive area does not need to be adapted to show graphics. It is merely adapted to senses touch at multiple locations similar to a touch screen.

In the embodiment shown in FIG. 1, the device 12 comprises a touch screen 16 and a touch pad 18 on the front face of the device. The touch screen 16 forms a display screen for the device, but also forms a user input section for the device. In an alternate embodiment, the device might merely comprise a touch screen covering substantially all of the front face of the device. A keypad area could be generated on the display screen of the touch screen.

The user can use the stylus 14 to depress a point on the touch screen 16 to select an icon or data on the display screen. In the past, the device merely processed the information of where the touch screen was depressed, regardless of how the stylus was used to depress the touch screen. In the past, the role of the stylus with touching the touch screen in this interaction was essentially “dumb”. The apparatus 10, on the other hand, has an enhanced “smart” interaction role of the stylus or pointing device with the touch screen; providing an added level of user input, but not necessarily by using physical contact between the stylus and the touch screen. This enhanced “smart” interaction is provided by sensing or determining the angular position of the stylus 14 relative to the device 12.

There are multiple different technical ways to determine an angle or angular position between a main surface of the touch screen 16 of the device 12 and the stylus 14. One possible way is explained to demonstrate that the idea is possible to implement. The touch screen 16 forms a two-dimensional (2D) surface (in axes X and Y) in three-dimensional (3D) space (X, Y, Z). The stylus 14 forms a 2D line 20 in the 3D space; a line along its longitudinal axis. It is possible to calculate the angle between the main surface (X-, Y-) of the touch screen 16 and the line 20 of the stylus 14.

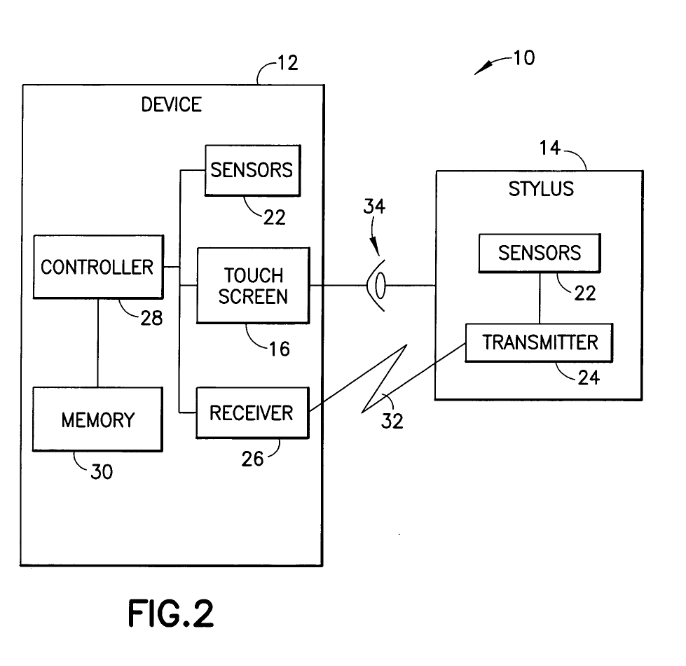

Referring also to FIG. 2, in this embodiment the device 12 and/or the stylus 14 can include sensors 22 that can calculate the direction of the stylus relative to the screen surface in the 3D space. Also, the stylus 14 can include a transmitter 24 which can transmit this information to the system in the device 12 by a wireless link 32, for example via BLUETOOTH® or by other means such as any suitable wireless link to the receiver 26 of the device 12. In an alternate embodiment, such as when the stylus 14 does not have sensors, the transmitter 24 might not be provided. The system software used by the controller 28 in the device 12 can then combine the information (screen and stylus angle information) and calculate the angle of the stylus when compared to the main surface of the screen. This can include use of information in the memory 30. The direction of the stylus (stylus angle) can be a combination of Y- and X-angles as shown in FIG. 1. This angle or direction information can be used by the software of the device 12, in combination with the identification of location of contact by the stylus on the touch screen as indicated by area 34, to perform an operation. The operation can be any suitable operation including changing the display screen or a portion of the display screen (including a pop-up window or pull-down menu appearing or disappearing for example), or selecting an application or function to be performed, or any other suitable user input operation. FIG. 3 shows the stylus moved to another location and another stylus angle which can be determined by the sensing system of the apparatus. The invention can use any suitable type of technical solution for detecting angular position of the pointing device, such as when the pointing device is a finger of a user. It could be based upon imaging technology such as described with reference to FIG. 12 below for example. Multiple cameras could be placed about the device screen. The software of the device could compare images taken from different directions and calculate the angle of the finger in three dimensional space.

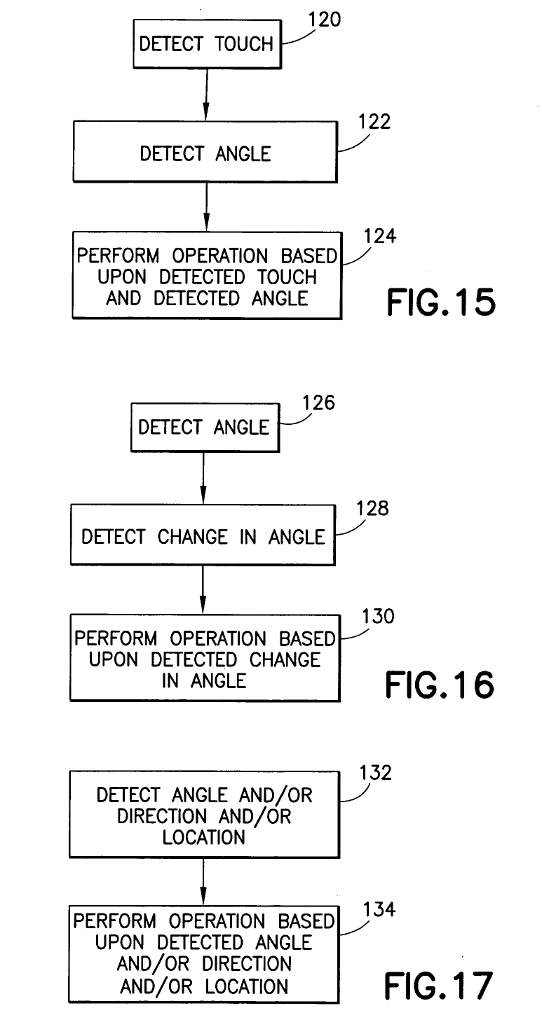

Referring also to FIG. 15, the apparatus and method can comprise detecting or sensing touch of the pointing device 14 on the touch sensor 16 as indicated by block 120. The apparatus and method can detect or sense the angle of the pointing device 14 relative to the apparatus, such as relative to the touch screen, as indicated by block 122. The apparatus and method can then perform an operation based upon the detected touch and the detected angle as indicated by block 124. In this type of embodiment, the detection of the pointing device touching the touch screen 16 initiates the detection of the angle of the pointing device. However, in an alternate embodiment, initiation of detection of the angle might occur before the pointing device touches the touch screen. The apparatus and method can also be adapted to perform the operation based upon the specific location or point on the touch screen which is touched. The operation could also be determined based upon the type of touch by the pointing device on the touch screen, such as a long duration touch versus a short duration touch selecting different operations.

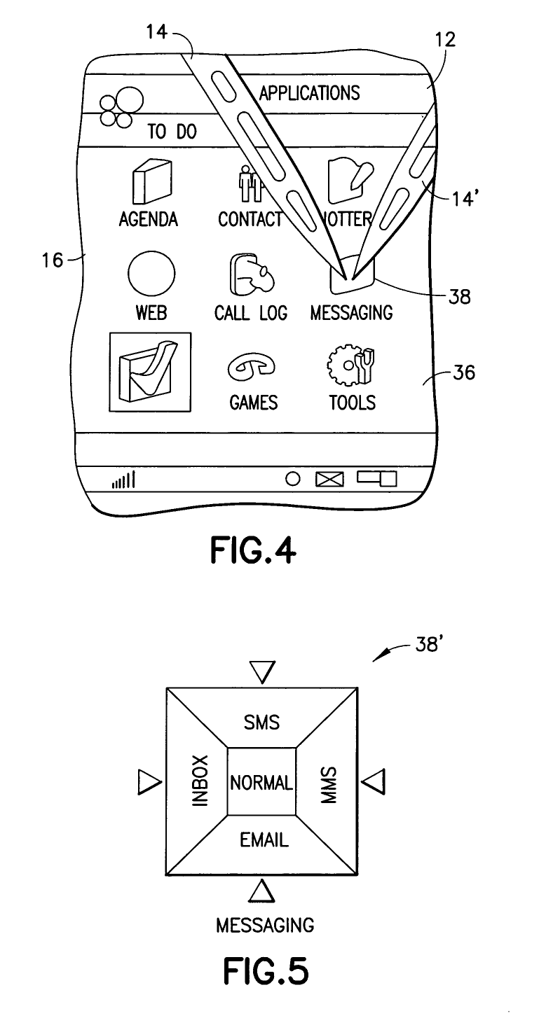

Referring also to FIG. 4, the interaction method described above can be used to activate different functions on a touch screen by tapping a same point on the touch screen. With the invention, a single point on a display screen 36 of the touch screen 16 can have many functions associated with it. Different functions can be activated based on the stylus angle (angle between stylus and screen). For the example shown in FIG. 4, the single “Messaging” icon 38 can include many functions. The messaging icon 38 on the display screen 36 shown on the touch screen 16 might include the following functions: inbox, new SMS, new MMS, email and normal messaging application view. The function is selected based upon the stylus 14 depressing the touch screen at the icon 38 and the stylus angle as illustrated by the examples 14 and 14′ shown in FIG. 4.

Detecting a change in the angle of the pointing device, such as from the first position of 14 in FIG. 4 to the second position 14′, can be used to select an operation and/or perform an operation. Referring also to FIG. 16, the apparatus and method can comprise detecting an angle of the pointing device as indicated by block 126. The apparatus and method can then detect a change in the angle, such as from a first angle to a second different angle, as indicated by block 128. The apparatus and method can be adapted to perform an operation based, at least partially, upon the detected change in angle as indicated by block 130. In one type of embodiment the detection of the angle can be continuous or continuing for a period of time to provide real time feedback and change by user selection of the angle.

If the user presses the messaging icon 38 with the stylus 14 from a left angle, an inbox display screen or window can be opened on the screen 16. If user presses the messaging icon 38 with the stylus 14 from upward direction, a new SMS display screen or window can be opened on the screen 16. If the user presses the messaging icon 38 with the stylus 14 from a right angle, a new MMS display screen or window can be opened on the screen 16. If the user presses the messaging icon 38 with the stylus 14 from a downward angle, an email display screen or window can be opened on the screen 16. If user presses the messaging icon with the stylus directly towards the touch screen surface, a normal messaging application display screen or window can be opened on the screen 16. So according to this example of a feature of the invention, an icon can have different functions which can be selected based upon a combination or the user pressing the icon with the stylus and based upon the angle of the stylus relative to the touch screen. In one example, this type of multi-feature icon (stylus angle dependent) can be indicated to the user by a 3D icon which has different sides that indicate these different functions as shown by the example of the messaging icon 38′ in FIG. 5. With the invention an icon can have different functions based upon a combination of the pressing of the icon and the angle of the pointing device, such as during pressing of the icon. The different functions could also be based upon a combination of the approaching direction of the pointing device above the touch screen (such as towards the icon or towards the touch screen from outside the touch screen) and the subsequent pressing of the icon.

With the invention, as an example only, different messaging applications can be launched by tapping a messaging icon from different angles. Tapping from an upper-left direction could, for example, open received messages. Tapping from an upper-right direction could open a dialog window for creating a new message. Other directions could still activate other functionalities if needed.

The stylus angle could be used to affect screen content. According to one feature of the invention, screen content on a device screen can change based on the stylus angle. It is also possible to change the screen content based upon both the stylus angle information and also stylus location information on the screen. For example, a user could make a virtual keyboard visible as the display screen by touching the touch screen 16 on a certain angle or, in the case of a capacitive touch screen for example, the user could bring the stylus on top of the touch screen in a certain angle that would make the virtual keyboard become visible. If the user taps the screen area in some other angle, the virtual keyboard could then disappear and another display screen could become visible. In one type of embodiment, the place where a finger moves on top of the screen could be detected and the device could act accordingly.

It is also possible to provide an embodiment in which only a part of the display screen area of the touch screen reacts to the stylus angle. For example, an upper part of the touch screen might not be affected by the stylus angle, but in the lower part of the touch screen a certain stylus angle could activate a virtual keyboard, certain functionality, or any other action could become active, etc.

According to one feature of the invention, the display screen orientation on the touch screen can be changed based upon the angle of the stylus. For example, the display screen can move to a landscape mode when the stylus is in an angle that is a typical stylus angle when using the device is in landscape mode. Similarly, the display screen can move to a portrait mode when the stylus is in an angle that is typical of a stylus angle when using the device in a portrait mode.

In one type of embodiment, the software of the device could comprise a touch screen “keylock” which could prevent user input until the “keylock” was unlocked by the user. In order to unlock the keylock feature, the device could be programmed to unlock the keylock feature only when the pointing device is moved over the screen from a certain direction or along a certain path (such as a check (✓) path or similar multi-directional path. If the pointing device is moved over the screen other than this unlock direction or path, the keylock would not be unlocked. The unlock procedure could also require, in combination with the pointing device unlock direction/path, the touch screen to be tapped with the pointing device at a certain location or from a certain angle. If other angles or locations are detected, the keylock would not be opened. These are merely examples and should not be considered as limiting.

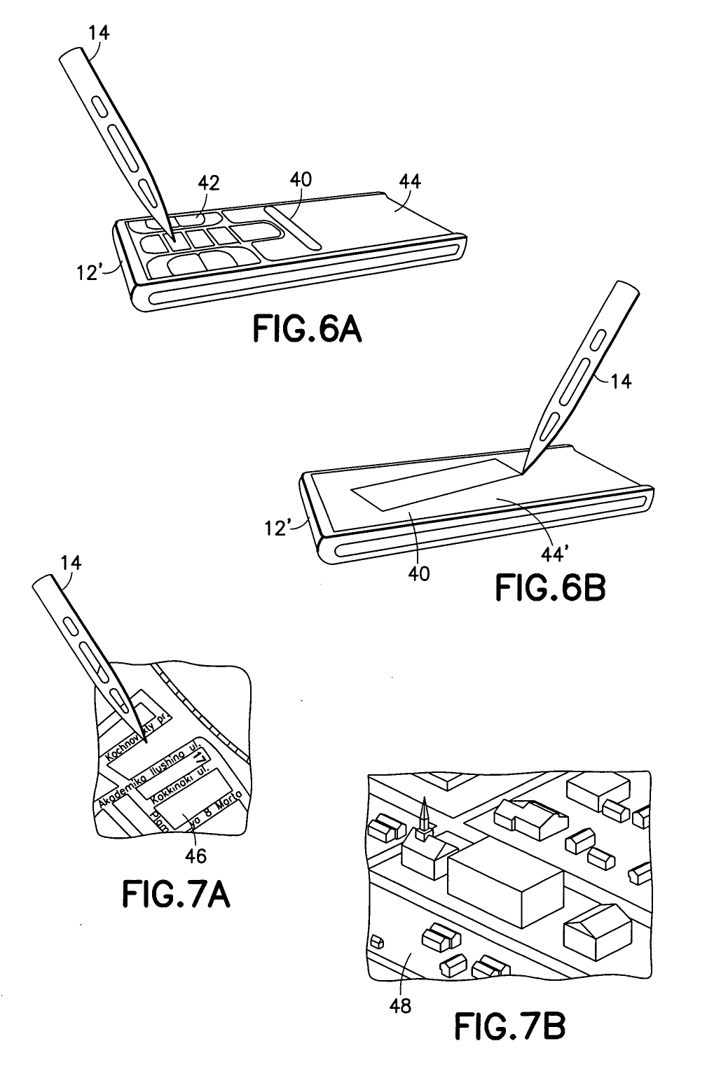

Referring also to FIGS. 6A and 6B, in this example the touch screen 40 covers almost the whole front cover of the device 12′. If the stylus 14 is used in a left angle, then a keypad area 42 and content area 44 are shown on as the display screen. If the stylus 14 is used in a right angle then the whole display screen is changed to a content area 44′ where the user can, for example, draw or write such as shown in this image.

Real time changing of the stylus angle (as opposed to merely a static sensing at one instance) can also be sensed and used. There are lots of possible actions and functions that can be done or activated by sensing the changing of the stylus angle. For example, a user can place the stylus to a certain part of a screen and then change the angle of stylus while keeping the point of the stylus at the same place on the screen. This can, for example, be used to change music volume for instance. A user can put the stylus on top of volume icon and change the stylus angle towards the right to increase volume or change the stylus angle towards the left to decrease volume. As another example, this same type of stylus movement could be used to change color or shade or sharpness in a picture. Change of stylus angle can also be used for scrolling content, drawing different items to the screen, to input text by changing the angle to select different characters (perhaps similar to a joystick movement). In addition to this, multiple other possibilities exist. As another example, the software could be programmed to input text, such as pressing a virtual keyboard on a touch screen, wherein a first sensed angle of the stylus could give a normal lower case letter, a second sensed angle of the stylus at the same location could give a capital letter, and a third sensed angle of the stylus at the same location could give a numeral, character or function. These are only some examples.

Another type of movement can comprise both the angle of the stylus and the location of the stylus on the touch screen changing at the same time. This too could be sensed/determined and the application software could react accordingly. For example, this dual type of motion of the stylus could be used to change the brightness and contrast of a picture at the same time, such as the angle of the stylus adjust the brightness and the location of the tip of the stylus on the touch screen adjusting the contrast. Again, this is merely an example and should not be considered as limiting the invention. The invention could also be used with multi-touch screens, such as used in the APPLE® IPHONE™. With a multi-touch screen, the invention could be used to sense angles of multiple simultaneous touches, such as by multiple fingers or a finger and a stylus for example.

Another feature of the invention can comprise combining information regarding the stylus angle to other input methods, stylus inputs and/or to other device information. Still new functionality can be achieved by combining the change of angle information and information related to the moving of the stylus. According to still another feature, the stylus angle information can be combined with the information which tells the location on the touch screen that first detects the presence of the stylus (valid especially in the case of capacitive touch screen) when the stylus is moved on top of or over (spaced from) the touch screen area. The stylus angle information can also be combined with other device input methods such as key presses, sensor information, etc. Stylus angle information can also be combined with other stylus actions such as double tapping the touch screen or a long press of the stylus on the screen.

Device profiles can be used to also change the current setup related to the use of the stylus angle information. Device settings can be used to define what actions are related to a stylus angle and what the angle range limits are for certain actions. For example, a mobile telephone could have a first device profile for meetings and a second device profile for mass transit. The user can select the device profile based upon his or her environment. In the first device profile a first stylus angle on a first icon could have a first effect or operation, but in the second device profile the same first stylus angle on the first icon could have a different second effect or operation.

Referring also to FIGS. 7A and 7B, in one example the invention can be used with a map related application where the stylus 14 can be used to change the direction of a 3D map. Naturally, the invention can also be used in other ways, such as with user interface components. The invention might allow creation of totally new types of user interface interactions. The following examples explain multiple different ways to use information related to stylus angle.

In the embodiment shown in FIGS. 7A and 7B, the invention could be used for viewing 3D map content. Different angles of the stylus 14 can be used to change the angle of the 3D view of a map. A user might first have a 2D map image 46 as the display screen as shown by FIG. 7A. If needed, the user can tap the touch screen with the stylus 14 so that the angle of the stylus 14 demonstrates the direction of the view to the subsequent 3D map image 48 as shown in FIG. 7B.

FIGS. 7A and 7B show how the user can tap the 2D map image from a certain angle and in the next phase the device shows the map from that viewing angle. These figures illustrate how the user can press the touch screen for a “smart” interaction between the stylus and the device to produce a multitude of different operations with a single touch of the touch screen on a single area of a same display screen. Depending on the angle of the stylus, the device can show the 3D map of the same area from any one of a plurality of different directions and angles. As noted above, real time variation can be provided by actively changing the angle and/or direction of the stylus while keeping the tip of the stylus on the same location of the touch screen. Similarly, sliding the tip of the stylus on the touch screen could change the location by sliding the 3D map image 48 on the touch screen accordingly.

The functionality of the invention does not have to be limited to only touch screen devices. It could be also possible to detect the stylus moves, screen presses and stylus angle without having to touch a touch screen on the device. In this case the device should be able to measure the stylus location in relation to the device without sensing the touch of the stylus. This could be done with a capacitive touch screen and/or additional sensors.

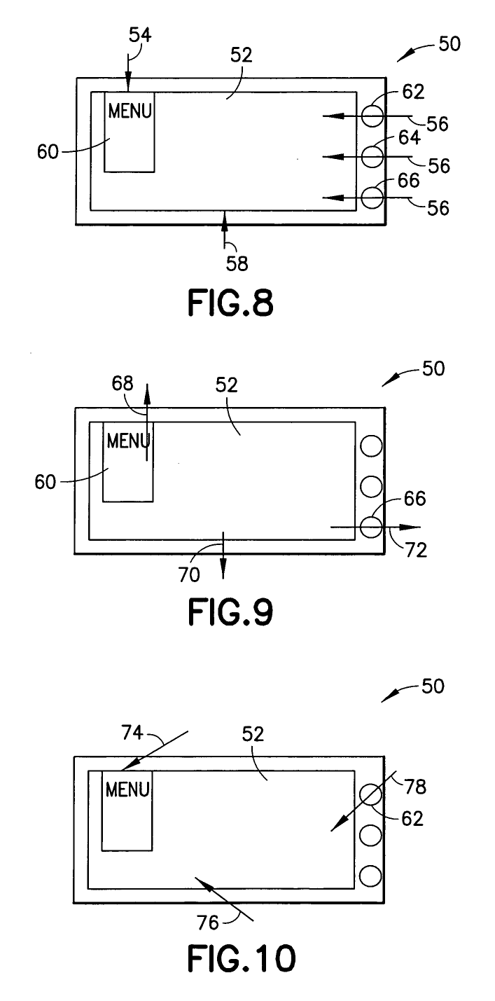

Referring also to FIG. 8, according to one example of the invention, a user can move the stylus to the touch screen 52 of the device 50 from different directions 54, 56, 58. The user can, for example, move the stylus to the touch screen 52 from an up-direction 54 and from the upper-left corner of the screen. In that case, a menu 60 is opened on the display screen when the user moves the stylus over and spaced from the touch screen 52. The user can also activate certain button functionalities. For example, moving the stylus towards the touch screen 52 from the direction 56 of over and spaced from one of the hardware keys 62, 64, 66 can cause the device 50 to perform the function associated with that key; without the user actually touching that key. The keys 62, 64, 66 could form touch sensors. Thus, the “location of movement” of the pointing device can be sensed or determined and an operation performed based upon that “location of movement.” Hence, a method of the invention can comprise determining a location of the pointing device based upon movement of the pointing device at that location relative to the user interface of the apparatus while the pointing device is spaced from the apparatus, such as movement over one of the hardware keys 62, 64, 66 for example. The apparatus and method can then perform an operation based, at least partially, upon the determined “location of movement” of the pointing device relative to the apparatus for at least partially entering a selection into the apparatus, such as over one of the hardware keys 62, 64, 66 for example. Still another functionality can be activated when the user moves the stylus towards the touch screen 52 from the direction 58. Some directions and places on the edge of the screen might not have any special functionality. Those directions can be used when the user does not want any special functionality when moving stylus towards the screen area.

Referring also to FIG. 9, the system of the device 50 can also do different actions based on the information of the stylus moving out from above the touch screen 52. For example, a menu 60 can be closed when stylus is moved out of the screen area to the direction 68. Moving the stylus away from above the touch screen in a certain direction might not have any functionality assigned to it, such as shown with arrow 70. Moving the stylus away from above the touch screen in a certain direction, such as shown direction 72 over the key 66, might activate a button functionality of the key 66. Thus, moving the stylus away from above the touch screen in certain directions or different places, can perform certain predetermined respective operations.

Sometimes it would be nice that the device does not link any functionality to the place of the stylus when moved to the screen area. Because of that, it would be possible that moving to the screen in a certain angle would only activate the functionality described in this invention. For example, as shown in FIG. 10 a user can activate a feature by moving to the screen area from a certain angle 74, 76, 78; such as a 45 degree angle. If user moves to the screen area in a different angle, for example in a 90 degrees angle, no special actions are done. In an alternate embodiment, an inverse system could be provided wherein a user can activate a feature by moving to the screen area from a certain angle, such as a 90 degree angle, but the feature would not be activated for a 45 degree angle.

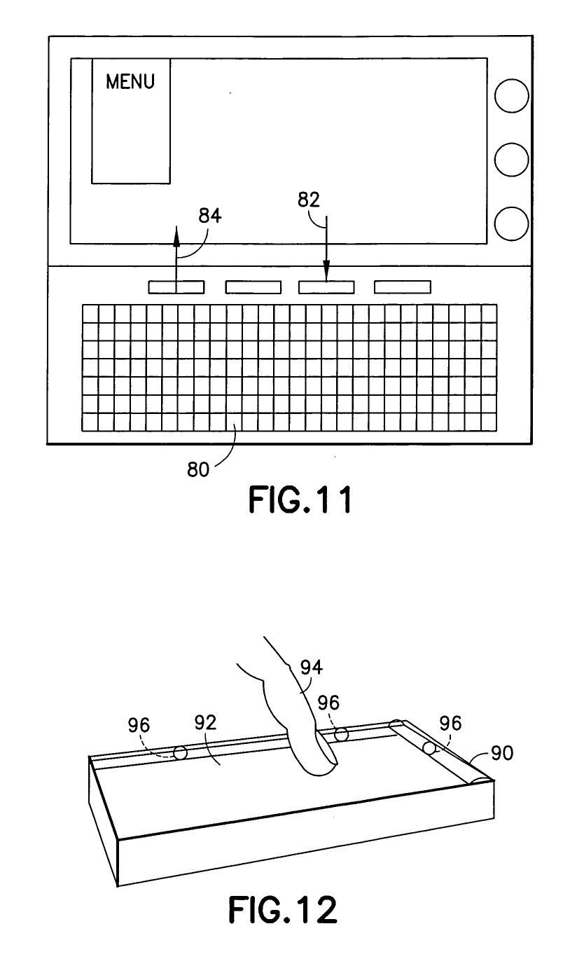

In the case of other form factors, the invention can have additional features. For example, referring also to FIG. 11, in a NOKIA® COMMUNICATOR type of device the keyboard 80 can also be touch sensitive. Thus, the direction (such as 82 and 84) of the stylus from and to the keyboard 80 can be detected. This gives possibilities for different type of functionality related to the moves of stylus.

Referring also to FIG. 17, as indicated by block 132 an apparatus and method of the invention can comprise detecting an angle and/or direction of movement and/or location of movement of the pointing device. As indicated by block 134, the apparatus and method can have software programmed or adapted to then perform at least one operation based upon the detected angle and/or direction of movement and/or location of movement of the pointing device. Thus, with this type of embodiment touch of the pointing device on the touch sensor might not be needed to perform a first operation. Subsequent touch of the pointing device on the touch sensor might perform a subsequent second operation based upon the first operation and the subsequent touch. The apparatus and method can also be adapted to perform the second operation based upon the specific location or point on the touch screen which is touched as well as based upon the first operation and the sensed touch. The second operation could also be determined based upon the type of touch by the pointing device on the touch screen, such as a long duration touch versus a short duration touch selecting different second operations.

In one additional feature of the invention, the device use orientation can be changed based on the direction of the stylus when moved to the screen area. For example if the stylus is moved above the screen from the right, the device can change its state to a portrait mode. If the stylus comes from an upward direction above the screen, the device use orientation can be changed to landscape. Also, the device user interface (UI) can be changed to better support left-handed people by flipping the user interface layout vertically. Other different screen and user interface modifications are possible based on information of the stylus movement direction and/or angle. It should be noted that the sensed angular rotation could be a rotational angle of the stylus axially rotating about its longitudinal axis. Features of the invention could also be combined with other touch screen user input systems including those described in U.S. patent application Ser. Nos. 10/750,525 and 10/830,192 for example, which are hereby incorporated by reference in their entireties.

Referring also to FIG. 12, in this embodiment the apparatus 90 has a touch screen or touch sensitive area 92 which is sensitive to the touch from a user's finger 94. The apparatus 90 includes a sensor 96, such as a camera for example, which can sense an angle of the user's finger 94. Two or more cameras 96 could be provided to detect the angle in three dimensions. The camera could be the camera used for taking digital photographs or videos with the software programmed to use it for angle sensing when not being used for picture taking. The apparatus could have a movable reflector to switch the path of the camera's view between normal and perpendicular. These are only some examples of sensing an angle of a finger and should not be considered as limiting the invention.

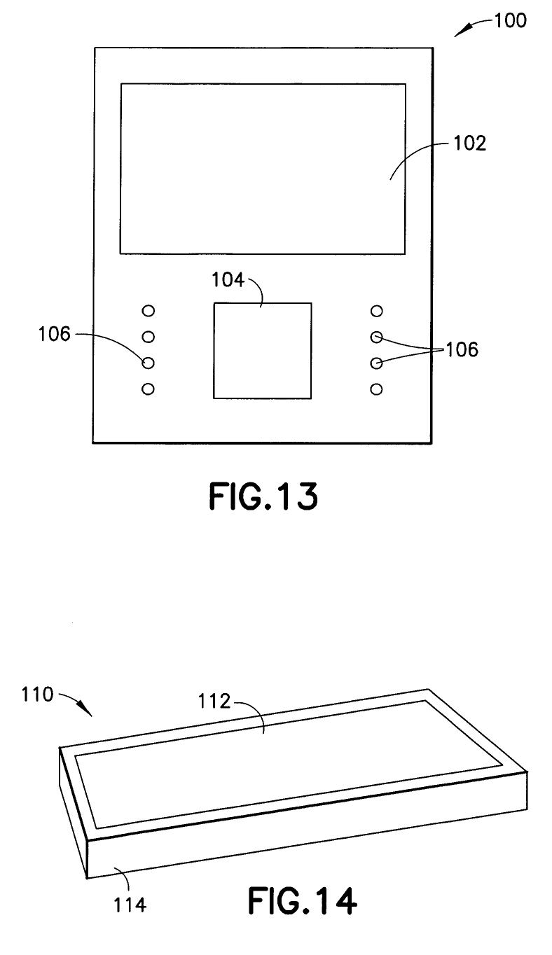

As mentioned above, the invention could also be used with a touch sensitive area which is not a touch screen. An example of this is shown in FIG. 13. In this embodiment, the apparatus 100 comprises a display screen 102 and a touch sensitive area 104 separate from the display screen. The user can use the stylus or a finger at the touch sensitive area 104 to control a selection or an application, such as movement of a cursor. For example, the angle sensors 106 of the apparatus 100 could sense whether the user was using his right or left hand on the touch sensitive area 104 and change the image on the display 102 to accommodate either a left or right handed user.

Referring also to FIG. 14, in this example the apparatus 110 comprises a touch screen 112 which is adapted to sense the stylus and/or finger as described above, and a touch sensitive cover 114. The touch sensitive cover 114 could be adapted to not only sense the location of touch be a user's hand or fingers, but also the angle of the user's finger(s). Similar to the embodiment described above, in one example, this could be used to sense whether a right-handed user or a left-handed user is using the apparatus, and the software could be adapted to operate differently based upon this sensed situation. Thus, a whole cover (or a majority of the cover) could be touch sensitive.

The invention could also be used with a multi-touch user input, such as a device that can sense multiple touches on a screen simultaneously for example. This type of user input may become more and more popular. The invention could be adapted to sense, detect or determine the presence of multiple pointing devices above the screen area, or touching the screen area and detecting the angle and/or other information separately for each of the pointing devices. This would further add possibilities for new user interface actions and functions. The pointing devices could be one or more stylus, and/or fingers, and/or other type of pointing device, or combinations of these.

The features of the invention described above with reference to the various different embodiments, can also be combined in various different combinations. All the different interaction methods mentioned above (angle, direction, location, duration, path, etc.) can be used together, in different combinations, when possible. Thus, the invention should not be considered as being limited to the described specific embodiments. These embodiments are merely intended to be exemplary.

It should be understood that the foregoing description is only illustrative of the invention. Various alternatives and modifications can be devised by those skilled in the art without departing from the invention. For example, features recited in the various dependent claims could be combined with each other in any suitable combination(s). Accordingly, the invention is intended to embrace all such alternatives, modifications and variances which fall within the scope of the appended claims.

What is claimed is:

1. A method of controlling a user interface of an apparatus comprising:
sensing a first angular position of a pointing device relative to the user interface of the apparatus; and
performing an operation based, at least partially, upon the sensed first angular position of the pointing device.

2. A method as in claim 1 wherein sensing the first angular position comprises the apparatus at least partially sensing the first angular position.

3. A method as in claim 1 wherein sensing the first angular position comprises the pointing device at least partially sensing the first angular position.

4. A method as in claim 3 further comprising the pointing device transmitting the at least partial sensed first angular position to the apparatus by a wireless link.

5. A method as in claim 1 wherein the operation comprises changing volume of sound from the apparatus, or scrolling of information on a display of the apparatus, or movement of a cursor on a display of the apparatus, or changing a view of a map on a display of the apparatus.

6. A method as in claim 1 further comprising:
sensing a second different angular position of the pointing device relative to the apparatus; and
performing a subsequent operation based, at least partially, upon change of the pointing device between the first angular position and the second angular position.

7. A method as in claim 6 wherein the subsequent operation comprises changing volume of sound from the apparatus, or scrolling of information on a display of the apparatus, or movement of a cursor on a display of the apparatus, or changing a view of a map on a display of the apparatus.

8. A method as in claim 6 further comprising sensing a location of a tip of the pointing device relative to a touch sensor of the apparatus.

9. A method as in claim 8 wherein performing the operation is based, at least partially, upon the location of the tip.

10. A method as in claim 6 further comprising:
sensing axial rotation of the pointing device relative to the apparatus; and
performing the subsequent operation based, at least partially, upon axial rotation of the pointing device and/or change in an axial rotation position of the pointing device between a first axial rotation position and a second different axial rotation position.

11. A method as in claim 1 further comprising:
sensing axial rotation of the pointing device relative to the apparatus; and
performing a subsequent operation based, at least partially, upon axial rotation of the pointing device and/or change in an axial rotation position of the pointing device between a first axial rotation position and a second different axial rotation position.

12. A method as in claim 1 further comprising sensing a location of a tip of the pointing device relative to a touch sensor of the apparatus.

13. A method as in claim 12 wherein performing the operation is based, at least partially, upon the location of the tip.

14. A method of controlling a user interface of an apparatus comprising:
sensing a first angular position of a pointing device relative to the user interface of the apparatus;
sensing a second different angular position of the pointing device relative to the user interface; and
performing a first operation based, at least partially, upon change of the pointing device between the first angular position and the second angular position.

15. A method as in claim 14 wherein sensing the first angular position comprises the apparatus at least partially sensing the first angular position.

16. A method as in claim 14 wherein sensing the first angular position comprises the pointing device at least partially sensing the first angular position.

17. A method as in claim 16 further comprising the pointing device transmitting the at least partial sensed first angular position to the apparatus by a wireless link.

18. A method as in claim 14 wherein the operation comprises changing volume of sound from the apparatus, or scrolling of information on a display of the apparatus, or movement of a cursor on a display of the apparatus, or changing a view of a map on a display of the apparatus.

19. A method as in claim 14 wherein the user interface comprises a touch sensor, and the method further comprises sensing a location of a tip of the pointing device relative to the touch sensor.

20. A method as in claim 19 wherein performing the operation is based, at least partially, upon the location of the tip relative to the touch sensor.

21. A method as in claim 14 further comprising performing a subsequent second operation based upon the first operation and touching the user interface with the pointing device.

22. A method as in claim 14 further comprising:
sensing axial rotation of the pointing device relative to the apparatus; and
performing a subsequent operation based, at least partially, upon axial rotation of the pointing device and/or change in an axial rotation position of the pointing device between a first axial rotation position and a second different axial rotation position.

23. A method of controlling a user interface of an apparatus comprising:
sensing a direction of movement of a pointing device relative to the user interface of the apparatus while the pointing device is spaced from the apparatus, and/or determining a location of the pointing device based upon movement of the pointing device at the location relative to the user interface of the apparatus while the pointing device is spaced from the apparatus; and
performing a first operation based, at least partially, upon the sensed direction of movement and/or the determined location of the pointing device.

24. A method as in claim 23 wherein sensing the direction of movement comprises the apparatus at least partially sensing the direction of movement.

25. A method as in claim 23 wherein sensing the direction of movement comprises the pointing device at least partially sensing the direction of movement.

26. A method as in claim 25 further comprising the pointing device transmitting the at least partial sensed direction of movement to the apparatus by a wireless link.

27. A method as in claim 23 wherein the operation comprises changing volume of sound from the apparatus, or scrolling of information on a display of the apparatus, or movement of a cursor on a display of the apparatus, or changing a view of a map on a display of the apparatus.

28. A method as in claim 23 wherein the user interface comprises a touch sensor, and the method further comprises sensing a location of a tip of the pointing device relative to the touch sensor.

29. A method as in claim 28 wherein performing the operation is based, at least partially, upon the location of the tip relative to the touch sensor.

30. A method as in claim 23 further comprising performing a subsequent second operation based upon the first operation and touching the user interface with the pointing device.

31. A method as in claim 23 further comprising:
sensing axial rotation of the pointing device relative to the apparatus; and
performing a second subsequent operation based, at least partially, upon axial rotation of the pointing device and/or change in an axial rotation position of the pointing device between a first axial rotation position and a second different axial rotation position.

32. A program storage device readable by an apparatus, tangibly embodying a program of instructions executable by the apparatus for performing operations to enter a selection into the apparatus, the operations comprising:
sensing a direction of movement of a pointing device relative to the apparatus while the pointing device is spaced from the apparatus and/or determining a location of the pointing device based upon movement of the pointing device at the location relative to the user interface of the apparatus while the pointing device is spaced from the apparatus; and
performing an operation based, at least partially, upon the sensed direction of movement and/or the determined location of the pointing device relative to the apparatus for at least partially entering the selection into the apparatus.

33. A program storage device readable by an apparatus, tangibly embodying a program of instructions executable by the apparatus for performing operations to enter a selection into the apparatus, the operations comprising:
sensing an angle of a pointing device relative to the apparatus while the pointing device is on the apparatus; and
performing an operation based, at least partially, upon the sensed angle of the pointing device relative to the apparatus for at least partially entering the selection into the apparatus.

34. An apparatus comprising:
a first section including a user interface comprising a touch sensor; and
a sensor system for determining an angular position of a pointing device relative to a portion of the first section.

35. An apparatus as in claim 34 wherein the sensor system comprises a sensor on the touch sensor.

36. An apparatus as in claim 34 wherein the sensor system comprises a sensor on the pointing device.

37. An apparatus as in claim 36 wherein the pointing device comprises a transmitter for transmitting information from the sensor to the apparatus by a wireless link.

38. An apparatus as in claim 34 wherein the sensor system is adapted to determine an angular position of the pointing device relative to the portion of the first section in two orthogonal axes.

39. An apparatus as in claim 34 wherein the portion comprises a touch screen.

40. An apparatus as in claim 34 wherein the sensor system is adapted to sense the pointing device relative to the portion of the first section while the pointing device is spaced from the first section, and wherein the apparatus further comprises electronic circuitry adapted to perform an operation based, at least partially, upon the sensing by the sensor system of the pointing device relative to the first section while the touch sensor actuator is spaced from the first section.

41. An apparatus as in claim 34 wherein the sensor system is adapted to sense a direction of movement of the pointing device relative to the first section while the pointing device is spaced from the first section and located over the touch sensor.

42. An apparatus as in claim 34 wherein the sensor system is adapted to sense a location of the pointing device relative to the first section while the touch sensor actuator is spaced from the first section and located over the touch sensor.

43. An apparatus as in claim 42 wherein the sensor system is adapted to sense a location of the pointing device as the pointing device passes over a perimeter edge of the touch sensor.

44. An apparatus as in claim 34 further comprising electronic circuitry adapted to perform an operation based, at least partially, upon the angular position of the pointing device as sensed by the sensor system.

45. An apparatus as in claim 44 wherein the operation comprises changing at least a portion of a display screen on the touch sensor.

46. An apparatus as in claim 44 wherein the operation comprises selecting information to be displayed on the touch sensor when the touch sensor is contacted by the pointing device based, at least partially, upon the angular position of the pointing device as sensed by the sensor system.

47. An apparatus as in claim 34 wherein the sensor system is adapted to sense a change in the angular position of the pointing device, and wherein the apparatus further comprises electronic circuitry adapted to perform an operation based, at least partially, upon the change in angular position of the pointing device as sensed by the sensor system.

48. An apparatus as in claim 47 wherein the operation comprises changing sound volume, or scrolling of information on the touch sensor, or movement of a cursor on the touch sensor.

49. An apparatus as in claim 34 further comprising means for sensing the angular position of the pointing device relative to the touch sensor comprising the sensor system.

50. An apparatus as in claim 34 further comprising means for performing an operation in the apparatus based upon the angular position of the pointing device sensed by the sensor system.

51. An apparatus as in claim 34 further comprising means for performing an operation in the apparatus based upon a sensed direction of rotation of the pointing device relative to the touch sensor.

52. An apparatus as in claim 34 further comprising means for performing an operation in the apparatus based upon a sensed direction of movement of the pointing device towards or away from the touch sensor.

53. An apparatus as in claim 34 wherein the touch sensor comprises a touch screen, and wherein the pointing device comprises a stylus.

54. An apparatus as in claim 34 wherein the touch sensor comprises a touch screen, and wherein the pointing device comprises a finger of a user.

55. An apparatus as in claim 34 further comprising a processing device for performing an operation based upon a signal from the sensor system.

56. An apparatus comprising:
a first section comprising electronic circuitry including a user input;
a pointing device adapted to be moved relative to the first section; and
a sensor system on the first section and/or the pointing device for sensing the pointing device relative to the first section while the pointing device is spaced from the first section,
wherein the electronic circuitry is adapted to perform an operation based, at least partially, upon the sensing by the sensor system of the pointing device relative to the first section while the pointing device is spaced from the first section.

57. An apparatus as in claim 56 wherein the user input comprises a touch sensor.

58. An apparatus as in claim 56 wherein the user input comprises a touch screen.
